(19) United States
(12) Patent Application Publication
(10) Pub. No.: US 2025/0168445 A1
(43) Pub. Date: May 22, 2025

(54) SIMULTANEOUS INTERPRETATION DEVICE, SIMULTANEOUS INTERPRETATION SYSTEM, SIMULTANEOUS INTERPRETATION PROCESSING METHOD, AND NON-TRANSITORY COMPUTER READABLE STORAGE MEDIUM

(71) Applicant: National Institute of Information and Communications Technology, Koganei-shi, Tokyo (JP)

(72) Inventors: Xiaolin WANG, Koganei-shi (JP); Masao UCHIYAMA, Koganei-shi (JP); Eiichiro SUMITA, Koganei-shi (JP)

(21) Appl. No.: 18/839,503

(22) PCT Filed: Mar. 16, 2023
(86) PCT No.: PCT/JP2023/010308

§ 371 Date: Aug. 19, 2024

(30) Foreign Application Priority Data
Apr. 18, 2022 (JP) 2022-068004

(51) Int. Cl. H04N 21/439; G10L 15/04; G10L 25/57

(52) U.S. Cl. CPC H04N 21/4394; G10L 15/04; G10L 25/57

(57) ABSTRACT

Provided is a simultaneous interpretation system that performs machine translation processing and speaker identification processing in real time. In the simultaneous interpretation system, the segment processing unit of the simultaneous interpretation device performs high-speed and highly accurate segment processing to obtain sentence data and also obtains a time range in which a word sequence included in the sentence data was uttered, thus, allowing for performing machine translation processing and speaker identification processing in real time. In other words, in the simultaneous interpretation system, the machine translation processing unit performs machine translation processing on sentence data obtained through high-speed and highly accurate segment processing, and performs, in parallel, processing for predicting a speaker who spoke during the period specified by the time range data based on the inputted video stream and the time range data, thus allowing for performing machine translation processing and speaker identification processing in real time.

### TECHNICAL FIELD

The present invention relates to multi-mode simultaneous interpretation technology, and for example, to technology for performing translation processing while identifying speakers in real time using audio and video signals with AV synchronization.

### BACKGROUND ART

In recent years, a simultaneous interpretation system (real-time interpretation system) has been developed that inputs a video stream (audio and video signals with AV synchronization), extracts audio from the video stream, performs automatic speech recognition and machine translation, thereby displaying the machine translation results (for example, as subtitles) on the video with audio obtained from the inputted video stream.

In such simultaneous interpretation systems, the machine translation results are displayed with them overlapped on the video with audio obtained from the inputted video stream, so that a user viewing the video can recognize what is being said.

However, with the above-described simultaneous interpretation system, it is sometimes difficult to understand who is saying what in a scene where multiple people are conversing. In other words, in such cases, the simultaneous interpretation system described above has a problem that the user cannot identify the speaker by looking only at the machine translation results displayed on the video with audio (e.g., as subtitles), and as a result, the user is confused.

Conversely, a conversation recording device has been developed that records audio data from meetings and other events in which multiple people speak, analyzes the recorded audio data, and identifies the speaker, making it possible to easily identify the content of speech and its speaker (e.g., see Patent Document 1). Specifically, the conversation recording device performs a clustering process on all speech features at the end of recording of a meeting, or the like, to determine the number of people who participated in the conversation and the representative speech features of each speaker, compares the speech features of each speaker with the recorded data to identify the speaker, and displays the content of the same speaker's speech by classifying it by color or display position, thereby providing distinguishable displays in which each speaker can be identified.

### PRIOR ART DOCUMENTS

### Patent Documents

Patent Document 1: Japanese Patent Application Laid-open No. 10-198393

### DISCLOSURE OF INVENTION

### Technical Problem

However, with the above technology, it is necessary to analyze the recorded speech data to identify the speaker after recording speech data, and thus speaker identification cannot be performed in real-time processing (processing that guarantees that the time from the start of processing to the end of processing (delay time) will be within a certain time).

In view of the above problems, an object of the present invention is to provide a simultaneous interpretation system capable of performing automatic speech recognition processing, machine translation processing, and speaker identification processing in real time.

### Solution to Problem

To solve the above problems, a first aspect of the present invention provides a simultaneous interpretation device including a speech recognition processing unit, a segment processing unit, a speaker prediction processing unit, and a machine translation processing unit.

The speech recognition processing unit performs speech recognition processing on a video stream including time information, an audio signal, and a video signal to obtain word sequence data corresponding to the audio signal; the word sequence data includes time information on when each word in the word sequence was uttered.

The segment processing unit obtains sentence data, which is segmented word sequence data, by performing segment processing on the word sequence data, and obtains time range data that specifies a time range in which the word sequence included in the sentence data was uttered.

The speaker prediction processing unit predicts a speaker who speaks in a period specified by the time range data, based on the video stream and the time range data.

The machine translation processing unit performs machine translation processing on the sentence data to obtain machine translation processing result data corresponding to the sentence data.

In the simultaneous interpretation device, the segment processing unit performs high-speed and highly accurate segment processing to obtain sentence data, and also obtains data for the time range in which the word sequence included in the sentence data was uttered, thus allowing for performing machine translation processing and speaker identification processing in real time. In other words, in the simultaneous interpretation device, the machine translation processing unit performs machine translation processing on sentence data obtained through high-speed and highly accurate segment processing, and performs, in parallel, processing for predicting a speaker who spoke during the period specified by the time range data based on the inputted video stream and the time range data, thus allowing for performing machine translation processing and speaker identification processing in real time (processing that is guaranteed to be completed within a predetermined delay time).

A second aspect of the present invention provides the simultaneous interpretation device of the first aspect of the present invention in which the speaker prediction processing unit includes a video clip processing unit, a speaker detection processing unit, an audio encoder, a face encoder, and a speaker identification processing unit.

The video clip processing unit obtains a clip video stream, which is data for a period specified by the time range data, from the video stream.

The speaker detection processing unit extracts a face image region of a speaker from a frame image formed by the clip video stream.

The audio encoder performs audio encoding processing on the audio signal included in the clip video stream to obtain audio embedding representation data that is embedding representation data corresponding to the audio signal.

The face encoder performs face encoding processing on the image data forming the face image region of the speaker to obtain face embedding representation data that is embedding representation data corresponding to the face image region of the speaker.

The speaker identification processing unit identifies a speaker who uttered the speech reproduced by the audio signal included in the clip video stream, based on the audio embedding representation data and the face embedding representation data.

The simultaneous interpretation device identifies the speaker who uttered the speech reproduced by the audio signal included in the clip video stream, based on the audio embedding representation data and the face embedding representation data. In other words, this simultaneous interpretation device performs speaker identification processing using a small amount of embedding representation data, thus making it possible to perform speaker identification processing faster (with a smaller amount of calculations) and with higher accuracy.

A third aspect of the present invention provides the simultaneous interpretation device of the second aspect of the present invention further including a data storage unit that stores a speaker identifier that identifies the speaker, and stores the audio embedding representation data and the face embedding representation data that are linked to the speaker identifier.

The speaker identification processing unit performs best matching processing using (1) the audio embedding representation data obtained by the audio encoder and the face embedding representation data obtained by the face encoder, and (2) the audio embedding representation data and the face embedding representation data that have been stored in the data storage unit; and when a similarity score indicating a degree of similarity between the above two data sets in the best matching processing is greater than a predetermined value, the speaker identification processing unit identifies a speaker identified by the speaker identifier corresponding to the audio embedding representation data and the face embedding representation data stored in the data storage unit, which have been used for the matching processing in the best matching processing, as the speaker who uttered the speech reproduced by the audio signal included in the clip video stream.

Thus, the simultaneous interpretation device can perform speaker identification processing by referring to the data stored in the data storage unit.

Note that the degree of similarity between two data in the best matching processing is obtained based on, for example, cosine similarity and distance information (e.g., Euclidean distance) between the two data.

A fourth aspect of the present invention provides the simultaneous interpretation system including the simultaneous interpretation device according to any one of the first to the third aspects of the present invention, and a display processing device that inputs speaker identification data, which is data for identifying a speaker who uttered speech reproduced by the audio signal included in the video stream, obtained by the simultaneous interpretation device, and the machine translation processing result data corresponding to the sentence data obtained by the machine translation processing unit of the simultaneous interpretation device, and generates display data for displaying the speaker identification data and the machine translation processing result data in one or more predetermined image areas of a screen of a display device.

This allows the simultaneous interpretation system to display the machine translation results of the source language spoken by the speaker in a predetermined image area (the same image area on the display screen) together with the data that identifies the speaker, thus allowing a user to easily recognize “who said what”.

A fifth invention is a simultaneous interpretation processing method including a speech recognition processing step, a segment processing step, a speaker prediction processing step, and a machine translation processing step.

The speech recognition processing step performs speech recognition processing on a video stream including time information, an audio signal, and a video signal to obtain word sequence data corresponding to the audio signal, the word sequence data including time information on when each word in the word sequence was uttered.

The segment processing step obtains sentence data, which is segmented word sequence data, by performing segment processing on the word sequence data, and obtains time range data that specifies a time range in which the word sequence included in the sentence data was uttered.

The speaker prediction processing step predicts a speaker who speaks in a period specified by the time range data, based on the video stream and the time range data.

The machine translation processing step performs machine translation processing on the sentence data to obtain machine translation processing result data corresponding to the sentence data.

This achieves a simultaneous interpretation processing method having the same advantageous effects as the simultaneous interpretation processing device of the first aspect of the present invention.

A sixth aspect of the present invention is a program for causing a computer to execute the simultaneous interpretation processing method of the fifth aspect of the present invention.

This achieves a program for causing a computer to execute the simultaneous interpretation processing method having the same advantageous effects as the simultaneous interpretation processing method of the fifth aspect of the present invention.

### Advantageous Effects

The present invention provides a simultaneous interpretation system that performs automatic speech recognition processing, machine translation processing, and speaker identification processing in real time.

### BRIEF DESCRIPTION OF THE DRAWINGS

FIG. 1 is a schematic configuration diagram of a simultaneous interpretation system 1000 according to a first embodiment.

FIG. 2 is a schematic configuration diagram of a speaker prediction processing unit 3 of the simultaneous interpretation device 100 according to the first embodiment.

FIG. 3 is a diagram schematically showing a video (video with audio) formed from a video stream (one example) inputted into the simultaneous interpretation device 100.

FIG. 4 is a flowchart of segment processing performed by the simultaneous interpretation system 1000.

FIG. 5 is a diagram for explaining segment processing performed by the simultaneous interpretation system 1000.

FIG. 6 is a diagram for explaining speaker detection processing.

FIG. 7 is a flowchart of speaker prediction processing performed by the simultaneous interpretation system 1000.

FIG. 8 is a diagram schematically showing a screen when display data obtained by processing the video stream of FIG. 3 by the simultaneous interpretation system 1000 is displayed on a display device.

FIG. 9 is a diagram schematically showing a screen when display data obtained by processing the video stream of FIG. 3 by the simultaneous interpretation system 1000 is displayed on a display device.

FIG. 10 is a diagram schematically showing a screen when display data obtained by processing the video stream of FIG. 3 by the simultaneous interpretation system 1000 is displayed on a display device.

FIG. 11 is a diagram showing a CPU bus configuration.

### DESCRIPTION OF THE PREFERRED EMBODIMENTS

### First Embodiment

A first embodiment will be described below with reference to the drawings.

### 1.1: Configuration of Simultaneous Interpretation System

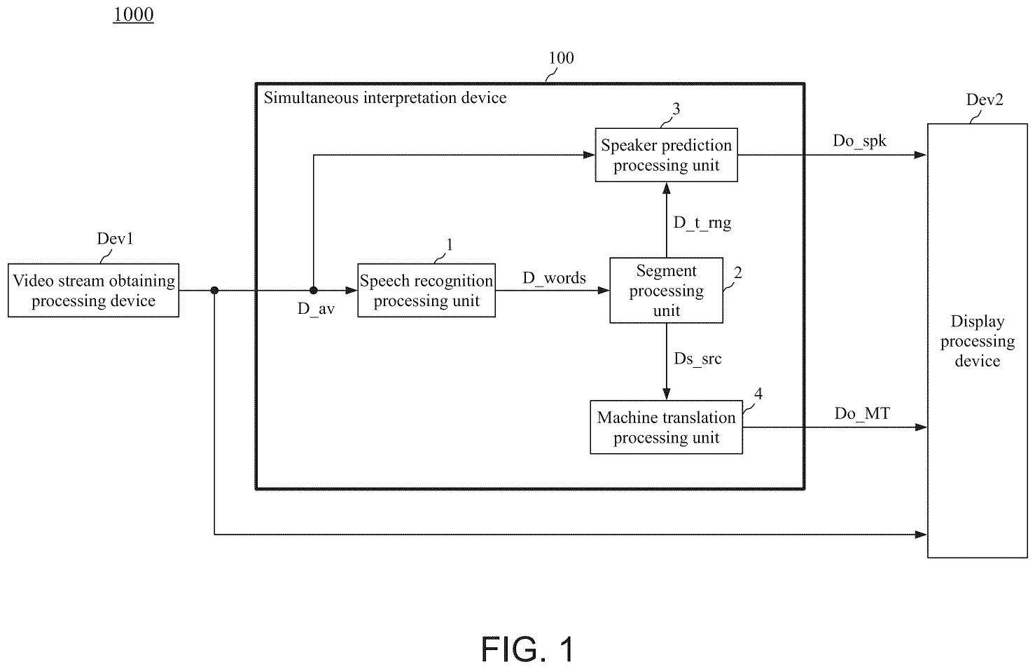

FIG. 1 is a schematic configuration diagram of a simultaneous interpretation system 1000 according to a first embodiment.

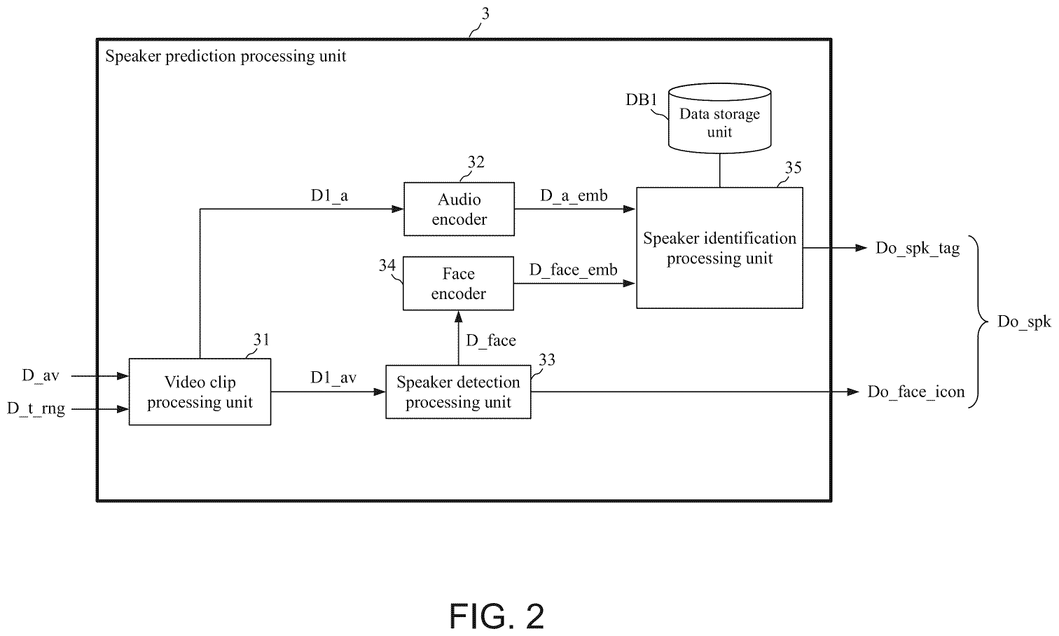

FIG. 2 is a schematic configuration diagram of a speaker prediction processing unit 3 of the simultaneous interpretation device 100 according to the first embodiment.

As shown in FIG. 1, the simultaneous interpretation system 1000 includes a video stream obtaining processing device Dev1, a simultaneous interpretation device 100, and a display processing device Dev2.

The video stream obtaining processing device Dev1 is a device that obtains a video stream (AV-synchronized audio signal and video signal). The video stream obtaining processing device Dev1 can be connected to, for example, an audio obtaining device (e.g., a microphone) and an imaging device (e.g., a camera), obtains an audio signal and a video signal from the audio obtaining device (e.g., a microphone) and the imaging device (e.g., a camera), and performs AV synchronization processing on the obtained audio signal and video signal, thereby obtaining a video stream (AV-synchronized audio signal and video signal). The video stream obtaining processing device Dev1 then transmits the obtained video stream (AV-synchronized audio signal and video signal) to the simultaneous interpretation device 100 as data D_av. The video stream obtaining processing device Dev1 also receives a video stream, for example, from an external recording device or from an external server (e.g., a streaming server or a video distribution server) via an external network (e.g., the Internet), and then transmits the obtained video stream to the simultaneous interpretation device 100 as data D_av. Note that the audio signal and the video signal inputted into the video stream obtaining processing device Dev1 each include time information (e.g., timestamp); when AV synchronization has not been established, the video stream obtaining processing device Dev1 obtains an AV-synchronized audio signal and video signal based on the time information (e.g., timestamp) included in the audio signal and the video signal, and then transmits a video stream including the obtained audio signal and video signal (a video stream with AV synchronization), as data D_av, to the simultaneous interpretation device 100 and the display processing device Dev2.

As shown in FIG. 1, the simultaneous interpretation device 100 includes a speech recognition processing unit 1, a segment processing unit 2, a speaker prediction processing unit 3, and a machine translation processing unit 4.

The speech recognition processing unit 1 receives data D_av (data of a video stream (AV-synchronized video stream)) transmitted from the video stream obtaining processing device Dev1. The speech recognition processing unit 1 extracts audio data (audio signal) from the data D_av, performs speech recognition processing on the extracted audio data (audio signal) to obtain word sequences (word stream) corresponding to the audio data (audio signal) and time information on when each word included in the word sequences was uttered. The speech recognition processing unit 1 then transmits data including the obtained word sequence and the above-described time information to the segment processing unit 2 as data D_words.

The segment processing unit 2 receives the data D_words transmitted from the speech recognition processing unit 1. The segment processing unit 2 performs segment processing on the data D_words and divides the word sequences included in the data D_words into sentences, thereby obtaining sentence data.

The segment processing unit 2 then transmits the sentence data (word sequences separated by sentences (data of word sequences forming one sentence)) obtained through the segment processing to the machine translation processing unit 4 as data Ds_src.

Furthermore, the segment processing unit 2 performs segment processing on the data D_words to obtain information for a period (time range) during which the sentence was uttered based on the information for the word sequence constituting the sentence data when the sentence data was obtained. The segment processing unit 2 then transmits the obtained data including the information on the period (time range) to the speaker prediction processing unit 3 as data D_t_rng.

As shown in FIG. 2, the speaker prediction processing unit 3 includes a video clip processing unit 31, an audio encoder 32, a speaker detection processing unit 33, a face encoder 34, a speaker identification processing unit 35, and a data storage unit DB1.

The video clip processing unit 31 receives the data D_av (data of a video stream with AV synchronization) transmitted from the video stream obtaining processing device Dev1 and the data D_t_rng transmitted from the segment processing unit 2. The video clip processing unit 31 performs clip processing on the video stream data included in the data D_av based on the data D_t_rng. Specifically, the video clip processing unit 31 obtains information for a period (time range) from the data D_t_rng to obtain video stream data corresponding to the information for the period (time range) (video stream obtained during the period (the time range)). The video clip processing unit 31 then transmits the data of the obtained video stream to the speaker detection processing unit 33 as data D1_av. Furthermore, the video clip processing unit 31 extracts only audio stream data from the obtain video stream data, and then transmits the extracted audio stream data to the audio encoder 32 as data D1_a.

The audio encoder 32 receives the data D1_a (audio stream data) transmitted from the video clip processing unit 31, and performs encoding processing on the data D_a to obtain embedding representation data corresponding to the received data D_a (audio stream data (speech stream)). The audio encoder 32 then transmits the obtained embedding representation data to the speaker identification processing unit 35 as data D_a_emb.

The speaker detection processing unit 33 receives the data D1_av (video stream data) transmitted from the video clip processing unit 31, performs speaker detection processing on the data D1_av to detect an image region corresponding to a person speaking on a video with audio that is formed by the received data D1_av and then obtains speaker icon data based on the detected image region. The speaker detection processing unit 33 then transmits data including the obtained speaker icon data to the display processing device Dev2 as data Do_face_icon.

The speaker detection processing unit 33 performs speaker detection processing on the received data D1_av, detects an image region corresponding to the face of the person speaking on the video with audio formed by the received data D1_av, and then transmits data including an image signal (image data) forming the detected image region to the face encoder 34 as data D_face.

The face encoder 34 receives the data D_face transmitted from the speaker detection processing unit 33, performs encoding processing on the data D_face to obtain embedding representation data corresponding to the received data D_face. The face encoder 34 then transmits the obtained embedding representation data to the speaker identification processing unit 35 as data D_face_emb.

The speaker identification processing unit 35 receives the data D_a_emb (embedding representation data of audio data) transmitted from the audio encoder 32 and the data D_face_emb (embedding representation data of face image region data) transmitted from the face encoder 34. Further, the speaker identification processing unit 35 can perform data read processing or data write processing by outputting a data read command or a data write command to the data storage unit DB1.

The speaker identification processing unit 35 performs speaker identification processing by referring to the data D_a_emb (embedding representation data of audio data), the data D_face_emb (embedding representation data of face image region data), thereby identifying the speaker (details will be described later). The speaker identification processing unit 35 then transmits data on the speaker identified through the above processing (e.g., tag data for identifying the speaker) to the display processing device Dev2 as data Do_spk_tag.

Note that the data Do_face_icon transmitted from the speaker detection processing unit 33 to the display processing device Dev2 and the data Do_spk_tag transmitted from the speaker identification processing unit 35 to the display processing device Dev2 are collectively referred to as data Do_spk.

The data storage unit DB1 is a storage unit that can store and hold data, and is provided by using a database, for example. The data storage unit DB1 reads out the stored data based on a data read command from the speaker identification processing unit 35, and transmits the read-out data to the speaker identification processing unit 35. Further, the data storage unit DB1 stores data transmitted from the speaker identification processing unit 35 in a predetermined storage area of the data storage unit DB1 based on a data write command from the speaker identification processing unit 35.

Note that the data storage unit DB1 may be installed outside the simultaneous interpretation device 100.

The machine translation processing unit 4 receives the sentence data of the data Ds_src (translation source language (source language)) transmitted from the segment processing unit 2, and performs machine translation processing on the received source language sentence data Ds_src to obtain word sequence data (translation result data) of the translation language (target language for translation) corresponding to the source language sentence data Ds_src. The machine translation processing unit 4 then transmits the obtained translation result data (word sequence data of the target language for translation) to the display processing device Dev2 as data Do_MT.

The display processing device Dev2 receives the data D_av transmitted from the video stream obtaining processing device Dev1, the data Do_MT (machine translation result data) transmitted from the simultaneous interpretation device 100, and the data Do_spk (speaker identification data). The display processing device Dev2 generates data to be displayed on a display device (not shown) based on the video stream data D_av, the machine translation result data Do_MT, and the speaker identification data Do_spk.

### 1.2: Operation of Simultaneous Interpretation System

The operation of the simultaneous interpretation system 1000 configured as above will be described.

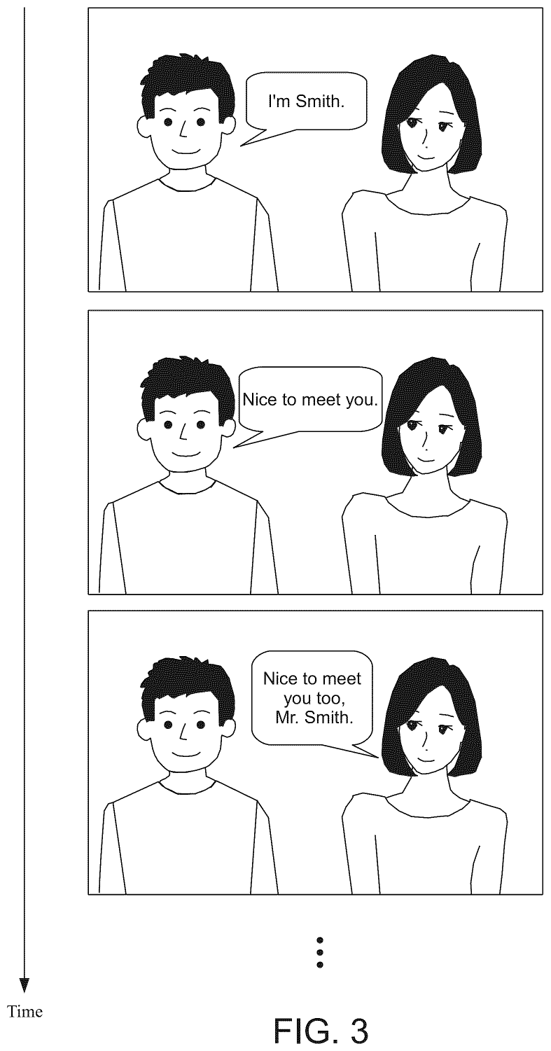

FIG. 3 is a diagram schematically showing a video (video with audio) formed from a video stream (one example) inputted into the simultaneous interpretation device 100.

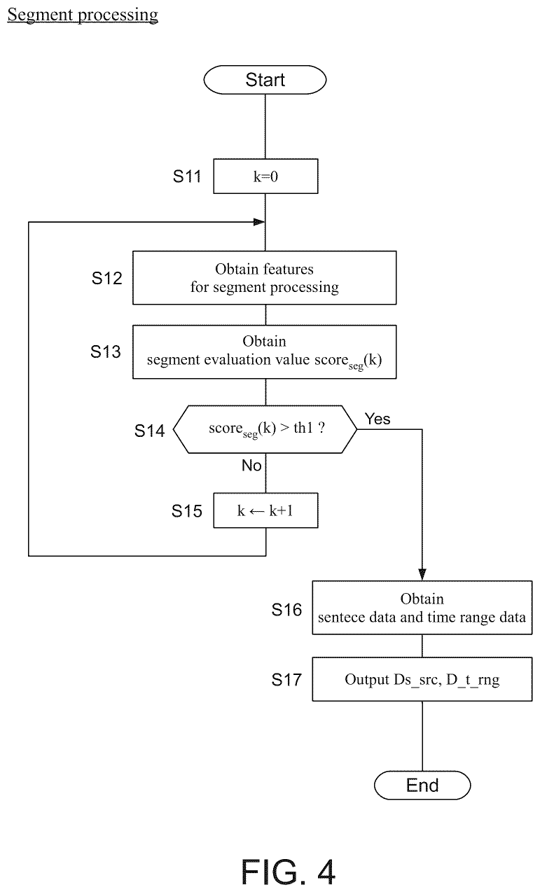

FIG. 4 is a flowchart of segment processing performed by the simultaneous interpretation system 1000.

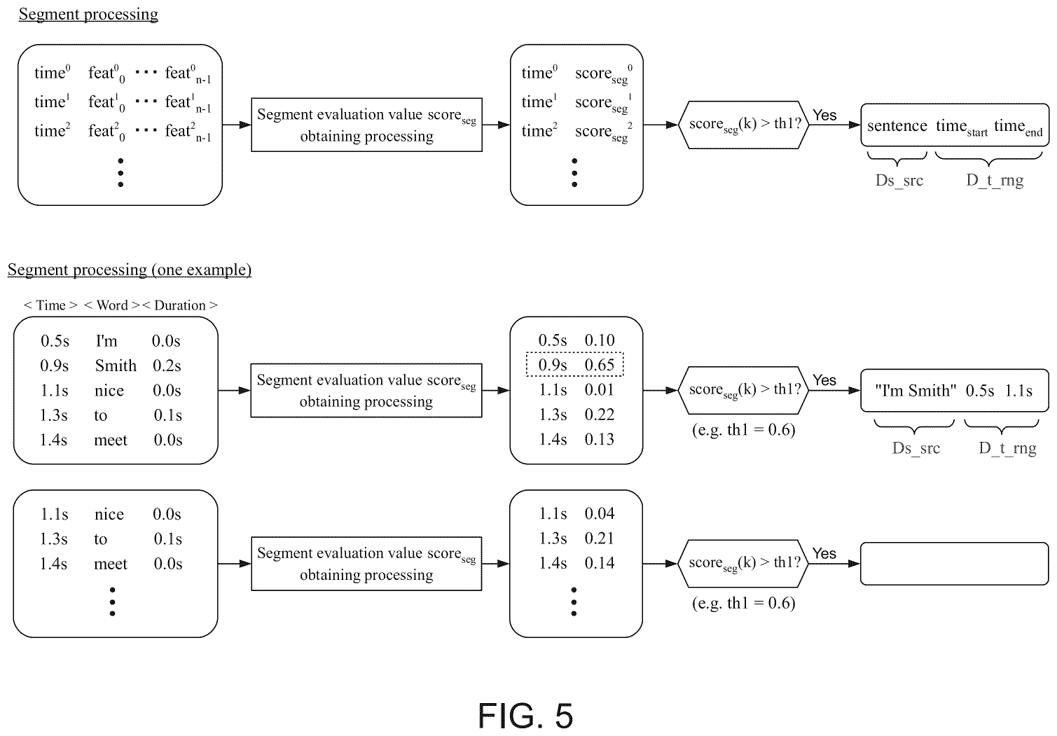

FIG. 5 is a diagram for explaining segment processing performed by the simultaneous interpretation system 1000.

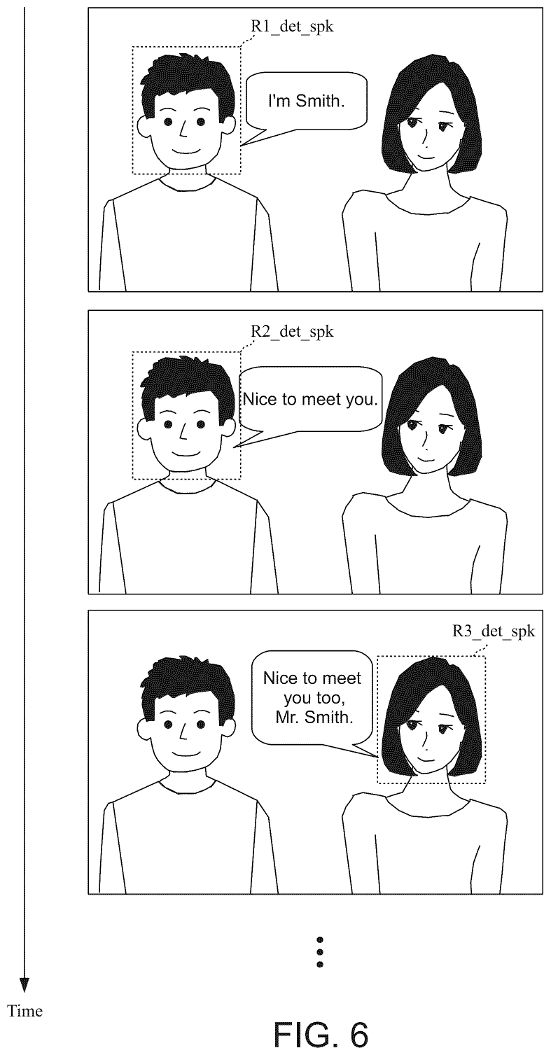

FIG. 6 is a diagram for explaining speaker detection processing.

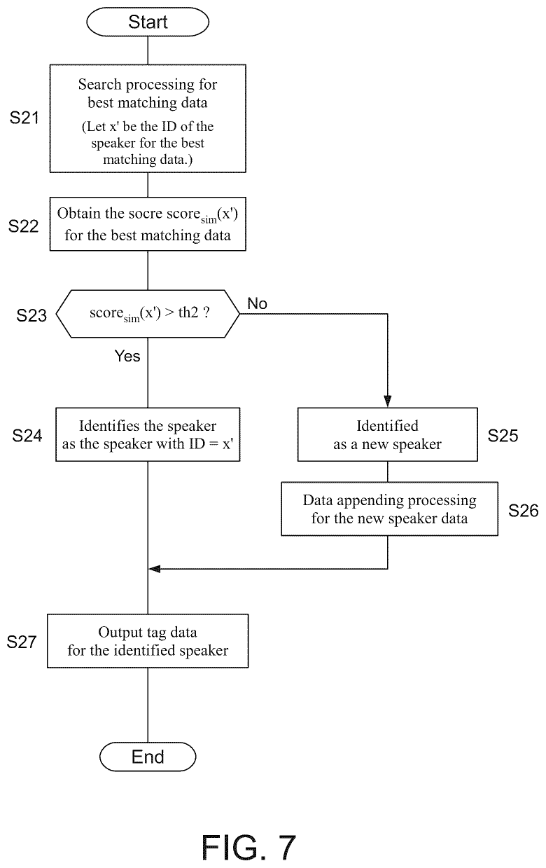

FIG. 7 is a flowchart of speaker prediction processing performed by the simultaneous interpretation system 1000.

The video stream obtaining processing device Dev1 obtains a video stream (AV-synchronized audio signal and video signal). For convenience of explanation, it is assumed that the video stream obtaining processing device Dev1 has obtained a video stream (AV-synchronized audio signal and video signal) forming the video (video with audio) shown in FIG. 3, a case in which the video stream is processed in the simultaneous interpretation system 1000 will be described below.

In addition, in FIG. 3, for convenience of explanation, the content of the spoken speech is displayed in text within a speech bubble, but in an actual video (video with audio), the speech bubble (and the text within it) does not exist on the video (video). In addition, in FIG. 3, some frame images (frame images extracted at a predetermined time) included in a video formed by a video stream are shown in chronological order, and not all the frame images included in the video formed by the video stream are shown.

In FIG. 3, for convenience of explanation, frame images displayed in FIG. 3 each show the sound (speech) that was uttered at a given time (period) as text within a speech balloon.

Furthermore, it is assumed that the video with audio formed from the video stream obtained by the video stream obtaining processing device Dev1 (the video with audio in FIG. 3) is a video of a scene where a man and a woman are having a conversation, and the two men and women are speaking in English (the source language (original language) for translation).

When the audio signal and video signal constituting the video stream to be processed are not AV-synchronized, the video stream obtaining processing device Dev1 performs AV-synchronization processing based on the time information (e.g., timestamp) of the audio signal and the time information (e.g., timestamp) of the video signal to obtain AV-synchronized audio and video signals. The video stream obtaining processing device Dev1 then transmits the obtained video stream (AV-synchronized audio signal and video signal) (video stream forming the video with audio in FIG. 3) to the simultaneous interpretation device 100 and the display processing device Dev2 as data D_av.

The speech recognition processing unit 1 of the simultaneous interpretation device 100 receives the data D_av (data of a video stream (AV-synchronized video stream)) transmitted from the video stream obtaining processing device Dev1. The speech recognition processing unit 1 extracts speech data (audio signal) from the received data D_av, and performs speech recognition processing on the extracted speech data (audio signal) to obtain word sequences (word stream) corresponding to the above-described speech data (audio signal) and time information (timestamp) at which each word included in the word sequences was uttered.

The speech recognition processing unit 1 obtains data (time-stamped word sequence data) in which each word is paired with time information (timestamp) when the word was uttered, for example, as shown below.
“I'm” (0.5 s)
“Smith” (0.9 s)
“nice” (1.1 s)
“to” (1.3 s)
“meet” (1.4 s)
. . . .

Note that in the above, the string (word sequence) in “ ” is the word data, and the number in parentheses ( ) is the time information (timestamp) indicated by the time (unit: seconds).

The speech recognition processing unit 1 then transmits data including the obtained word sequences and time information (time-stamped word sequence data) to the segment processing unit 2 as data D_words.

The segment processing unit 2 performs segment processing on the data D_words transmitted from the speech recognition processing unit 1. Specifically, the segment processing unit 2 performs the following processing. Note that the segment processing will be described with reference to the flowchart in FIG. 4 and the explanatory diagram in FIG. 5.

### Step S11:

In step S11, the segment processing unit 2 sets a variable k indicating the order of word sequences to an initial value (k=0).

### Step S12:

In step S12, the segment processing unit 2 obtains features for segment processing. Specifically, the segment processing unit 2 calculates n (n: natural number) features feat^{t}₀, feat^{t}₁, . . . , feat^{t}ₙ₋₁ at time time^{t}, where time information (timestamp) attached to a word is time^{t}. The above features are data necessary for performing segment processing and obtaining a segment evaluation value (segment score (e.g., a value indicating a probability that it is a delimiter in a word sequence (a value indicating a probability that it is a sentence delimiter (at the end of a sentence))). In the present embodiment, two features (that is, n=2) are used; the first feature is a word (data indicating a word), and the second feature is a duration of a pause (silence time) after each word.

### Step S13:

In step S13, the segment processing unit 2 obtains a segment evaluation value (segment score) score_{seg} based on the feature for segment processing. Specifically, the segment processing unit 2 performs processing corresponding to the following formula to obtain a segment evaluation value (segment score) score_{seg} (k) of the k-th word (a value indicating a probability that the k-th word (k is a natural number) is the end of a sentence (a delimiter for word sequences)).

$${score}_{seg} ( k ) = {F}_{seg} ( {feat}_{0}^{0} , … , {feat}_{n - 1}^{0} , … , {feat}_{0}^{k + K} , … , {feat}_{n - 1}^{k + K} ) \qquad Formula 1$$

F_{seg}(k): a function that returns a probability that the segment after the k-th word is a segment delimiter (a delimiter for word sequences (the end of a sentence)) (F_{seg}(k) is achieved by using, for example, a neural network model).

K: coefficient for obtaining context (K is a natural number) (inputting K features following the k-th word (in the future in time series) into the function F_{seg}(k) allows for obtaining a probability that is a segment delimiter with higher accuracy. Thus, in the above formula, K features following the k-th word (in the future in time series) are inputted into the function F_{seg}(k)).

Assuming that, in the present embodiment, the segment processing unit 2 performs segment processing by performing processing corresponding to the following equation as an example of implementing the above Formula 1.

$${score}_{seg} ( k ) = {score}_{RNN} ( {w}_{0} , … , {w}_{k + K} ) + α \times pause ( k ) \qquad Formula 2$$

In the above formula, Score_{RNN}(w₀, . . . , w_{k+K}) is a function that outputs a probability that a segment after the k-th word is a segment delimiter (the end of sentence) when a word sequence (sentence) consisting of k+K+1 words is inputted. Note that the processing corresponding to the above function can be achieved using a model (a trained model) provided by using an RNN (recurrent neural network), for example, as disclosed in Document A below.

Document A: Xiaolin Wang, Masao Utiyama, and Eiichiro Sumita, “Online sentence segmentation for simultaneous interpretation using multi-shifted recurrent neural network.” In Proceedings of Machine Translation Summit XVII Volume 1: Research Track, pages 1-11.

In the above formula, α is an adjustment coefficient (α is a real number), and pause (k) is a duration of a pause (silent period) after the k-th word (word wₖ) (e.g., the unit is seconds).

### Step S14:

In step S14, the segment processing unit 2 performs processing of comparing the segment evaluation value (segment score) score_{seg} (k) obtained in step S12 with a threshold value th1. As a result of the comparison processing, if score_{seg}(k)>th1 is satisfied, the segment processing unit 2 advances the process to step S16, whereas if score_{seg} (k)>th1 is not satisfied, the segment processing unit 2 advances the process to step S15.

### Step S15:

In step S15, the segment processing unit 2 increments the value of the variable k by +1, and then returns the process to step S12. The processes of steps S12 to S14 are then performed in the same manner as described above.

### Steps S16, S17:

In step S16, the segment processing unit 2 obtains data from the first word when the segment processing is started to the word after which the segment is determined to be delimited, as sentence data (data of a word sequence that constitutes a single sentence), and further obtains the time range data of the time information (timestamp) for the word sequence of the sentence data.

In step S17, the segment processing unit 2 transmits the sentence data obtained as described above to the machine translation processing unit 4 as data Ds_src, and transmits the time range data obtained as described above to the speaker prediction processing unit 3 as data D_t_rng.

A specific example of segment processing will now be described with reference to FIG. 5.

In FIG. 5, the upper diagram schematically shows input data, processing, and output data in segment processing, and the middle and lower diagrams in FIG. 5 schematically show input data, processing, and output data in segment processing when actual data is inputted. In FIG. 5, the first feature used for segment processing is word data, and the second feature is a duration (in seconds) of a pause (silent period) after the word to be processed.

The upper diagram of FIG. 5 schematically shows the following situation: the features feat^{k}₀, . . . , feat^{k}ₙ₋₁ at time time^{k} are obtained in sequence in time series by the segment processing unit 2, the segment evaluation value score_{seg}^{k} (=score_{seg} (k)) is obtained, and then the obtained segment evaluation value score_{seg}^{k} is compared with the threshold th1; if score_{seg} (k)>th1 is satisfied, (1) the character string (word sequence) “sentence” consisting of the 0-th to k-th words and (2) data on the time range during which the character string (word sequence) consisting of the 0-th to k-th words is spoken, that is, the speech start time timeₛₜₐᵣₜ of the character string and the speech end time time_{end} of the character string, are obtained.

As shown in the middle diagram of FIG. 5, at the time when the word “Smith” was inputted is 0.9 s (time¹=0.9 s) (the time is obtained from the time information (timestamp) attached to the word), the segment evaluation value score_{seg}^{k} (=score_{seg}(k), k=1) obtained by the segment processing is “0.65”, which is a value larger than the threshold value th1. It is assumed that the threshold value th1 is set to “0.6”. Thus, at this time, the segment processing unit 2 determines that there is a segment delimiter (the end of the sentence) after the first word “Smith” (the time is 0.9 s), and then obtains the word sequence from the 0-th word “I'm” (the time is 0.5 s) to the first word “Smith” (the time is 0.9 s) as sentence data (segmented word sequence data) Ds_src.

In addition, the segment processing unit 2 sets the time range in which the obtained sentence data was uttered to the duration from “time: 0.5 s” obtained from the time information (timestamp) of the 0-th word “I'm” to “time: 1.1 s” obtained from the time information of the next word (in the case of the middle diagram of FIG. 5, the word “nice”) after the first word “Smith” (the time is 0.9 s). In other words, the segment processing unit 2 sets timestart and timeend as follows:
timeₛₜₐᵣₜ=0.5 s (time information of the 0-th word), and
time_{end}=1.1 s (time information of the next word (the second word) after the first word),
   and then obtains data including the above information as time range data D_t_rng.

The segment processing unit 2 then transmits the data Ds_src obtained as described above to the machine translation processing unit 4, and transmits the data D_t_rng obtained as described above to the speaker prediction processing unit 3.

The segment processing unit 2 performs the same process as above on the word sequence starting from the next word determined to be a segment delimiter (in the case of FIG. 5, “nice” at time 1.1 s) (segment processing is performed using the word “nice” at time 1.1 s as a word at k=0), thereby allowing segment processing to be continuously performed.

The data Ds_src including the sentence data (word sequences separated by sentences (data of word sequences constituting one sentence)) obtained by the segment processing as described above is transmitted from the segment processing unit 2 to the machine translation processing unit 4. The time range data D_t_rng, which is information on the utterance period of the sentence data (word sequences separated by sentences (data of word sequences constituting one sentence)) obtained by the segment processing as described above, is transmitted from the segment processing unit 2 to the speaker prediction processing unit 3.

The video clip processing unit 31 of the speaker prediction processing unit 3 receives the data D_av (AV-synchronized video stream data) transmitted from the video stream obtaining processing device Dev1 and the data D_t_rng transmitted from the segment processing unit 2. The video clip processing unit 31 performs clip processing on the video stream data included in the data D_av based on the data D_t_rng. Specifically, the video clip processing unit 31 obtains information on a period (time range) from the data D_t_rng, and then obtains video stream data corresponding to the period (time range) (video stream obtained during the period (time range)). For example, in the case of FIG. 5, if the data Ds_src is “I'm Smith”, the time range data D_t_rng=(timeₛₜₐᵣₜ, time_{end})=(0.5 s, 1.1 s) is satisfied; thus, the video clip processing unit 31 obtains data for a period from time 0.5 s to time 1.1 s based on the data D_av, and sets the obtained data as data D1_av.

The video clip processing unit 31 then transmits the obtained video stream data D1_av to the speaker detection processing unit 33. Furthermore, the video clip processing unit 31 extracts only audio stream data from the obtained video stream data D1_av, and transmits the extracted audio stream data to the audio encoder 32 as data D1_a.

The audio encoder 32 receives the data D1_a (audio stream data) transmitted from the video clip processing unit 31, and performs encoding processing on the data D_a (processing for obtaining embedding representation data corresponding to the audio stream from the audio stream) to obtain embedding representation data corresponding to the received data D_a (audio stream (speech stream)). The audio encoder 32 then transmits the obtained embedding representation data to the speaker identification processing unit 35 as data D_a_emb.

The speaker detection processing unit 33 performs speaker detection processing on the data D1_av (video stream data) D1_av transmitted from the video clip processing unit 31, detects an image region corresponding to the person speaking in the video with audio that is formed by the received data D1_av, and then obtains speaker icon data based on the detected image region.

Note that this speaker detection processing can be achieved by using the technique disclosed in Document B below, for example.

Document B: Joseph Roth, Sourish Chaudhuri, Ondrej Klejch, Radhika Marvin, Andrew Gallagher, Liat Kaver, Sharadh Ramaswamy, Arkadiusz Stopczynski, Cordelia Schmid, Zhonghua Xi, and Caroline Pantofaru, “AVA-ActiveSpeaker: An Audio-Visual Dataset for Active Speaker Detection” 2019.

For example, in the case shown in FIG. 6, the speaker detection processing unit 33 obtains image regions R1_det_spk, R2_det_spk, and R3_det_spk corresponding to the person speaking in the video with audio formed by the data D1_av, and obtains an image with its area reduced as speaker icon data.

The speaker detection processing unit 33 then transmits data including the obtained speaker icon data to the display processing device Dev2 as data Do_face_icon.

The speaker detection processing unit 33 performs speaker detection processing on the received data D1_av, detects the face of the person speaking in the video with audio formed by the received data D1_av, and then transmits data including an image signal (image data) forming the detected image region to the face encoder 34 as data D_face.

The face encoder 34 receives the data D_face transmitted from the speaker detection processing unit 33 and performs encoding processing on the data D_face (using the image data (image signal) forming an image region corresponding to the face, the face encoder 34 performs processing for obtaining embedding representation data corresponding to the image data) to obtain embedding representation data corresponding to the received data D_face. The face encoder 34 then transmits the obtained embedding representation data to the speaker identification processing unit 35 as data D_face_emb.

The speaker identification processing unit 35 receives the data D_a_emb (embedding representation data of audio data) transmitted from the audio encoder 32 and the data D_face_emb (embedding representation data of face image region data) transmitted from the face encoder 34.

The speaker identification processing unit 35 performs speaker identification processing by referring to the data D_a_emb (embedding representation data of audio data), the data D_face_emb (embedding representation data of face image region data), and data stored in the data storage unit DB1, thereby identifying a speaker. It is assumed that the data storage unit DB1 has stored embedding representation data of face image region data and embedding representation data of audio data for each speaker, and the data is read out by the speaker identification processing unit 35. Note that the embedding representation data of the face image region data of a speaker with ID=x (this is referred to as “speaker x”) is expressed as vr*, and the embedding representation data of the audio data of the speaker with ID=x is expressed as vax.

The specific processing will be described with reference to the flowchart in FIG. 7.

### Step S21:

In step S21, search processing for best matching data is performed. Specifically, the following processing is performed.

The speaker identification processing unit 35 performs processing corresponding to the following formula to identify a speaker, with ID=x′, whose ID is the best matching data from among the data stored in the data storage unit DB1.

$${x}^{′} = {arg max}_{x} \{ cos ( {v}_{f} , {v}_{f}^{x} ) + cos ( {v}_{a} , {v}_{a}^{x} ) \} \qquad Formula 3$$

cos(v1,v2): function to obtain cosine similarity of v1 and v2

### Step S22:

In step S22, the speaker identification processing unit 35 obtains the similarity score scoresim(x′) of the speaker with ID=x′, which is the best matching data, by performing processing corresponding to the following formula.

$${score}_{sim} ( {x}^{′} ) = cos ( {v}_{f} , {v}_{f}^{{x}^{′}} ) + cos ( {v}_{a} , {v}_{a}^{{x}^{′}} ) \qquad Formula 4$$

cos(v1,v2): function to obtain cosine similarity of v1 and v2

### Step S23:

In step S23, the speaker identification processing unit 35 compares the similarity score scoreₛᵢₘ(x′) of the speaker with ID=x′ with a predetermined threshold th2; if scoreₛᵢₘ(x′)>th2 is satisfied, the process proceeds to step S24, whereas if scoreₛᵢₘ(x′)>th2 is not satisfied, the process proceeds to step S25.

### Step S24:

In step S24, the speaker identification processing unit 35 identifies the person (speaker) who is speaking in the video with audio formed by the data D1_av (video stream clipped in a time range) to be processed as the speaker with ID=x′.

### Step S25, Step S26:

In step S25, the speaker identification processing unit 35 determines that the data of the person (speaker) speaking in the video with audio formed by the data D1_av (video stream clipped in the time range) to be processed is not the data of any speaker stored in the data storage unit DB1.

In step S26, the speaker identification processing unit 35 then determines that the person (speaker) speaking in the video with audio formed by the data D1_av (video stream clipped in the time range) to be processed is a new speaker, and sets the ID of the speaker to a new ID that has not been stored in the data storage unit DB1 (e.g., if the IDs of the speakers stored in the data storage unit DB1 are within a range of 1≤ID≤M, the ID of the speaker is set to “M+1”). The speaker identification processing unit 35 then generates a data set (data linked with the ID) that combines the ID (the new speaker's ID), the embedding representation data of the face image region data of the speaker with the ID and the embedding representation data of the audio data of the speaker with the ID, and then stores the data set in the data storage unit DB1.

### Step S27:

In step S27, the speaker identification processing unit 35 obtains the tag data of the identified speaker (e.g., character string data for identifying the speaker), and then transmits the tag data to the display processing device Dev2 as data Do_spk_tag.

The machine translation processing unit 4 receives the sentence data of the data Ds_src (translation source language (source language)) transmitted from the segment processing unit 2, and performs machine translation processing on the received sentence data Ds_src of the source language to obtain word sequence data (translation result data) in the translation language (translation target language) corresponding to the source language sentence data Ds_src. The machine translation processing unit 4 then transmits the obtained translation result data (word sequence data of the translated language) to the display processing device Dev2 as data Do_MT.

The display processing device Dev2 receives the data D_av transmitted from the video stream obtaining processing device Dev1, the data Do_MT (machine translation result data) transmitted from the simultaneous interpretation device 100, and the data Do_spk (speaker identification data).

The display processing device Dev2 generates data to be displayed on a display device (not shown) based on the video stream data D_av, the machine translation result data Do_MT, and the speaker identification data Do_spk.

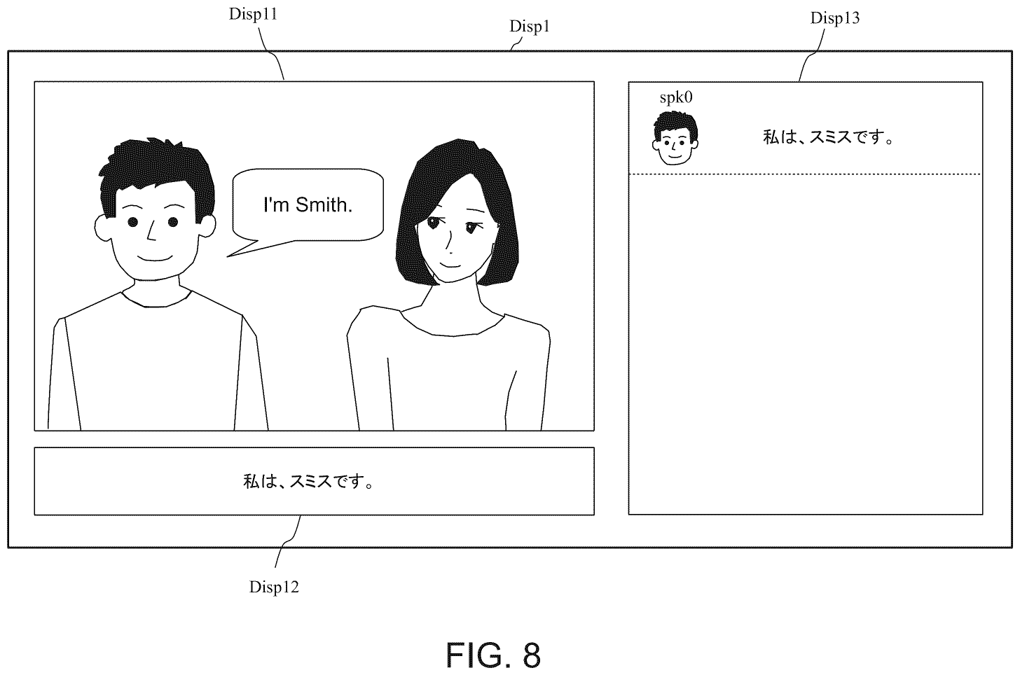

Here, specific examples of display data generated by the display processing device Dev2 will be explained using FIGS. 8 to 10.

FIGS. 8 to 10 are diagrams schematically showing screens when display data obtained by processing the video stream of FIG. 3 by the simultaneous interpretation system 1000 is displayed on a display device. In FIGS. 8 to 10, an area Disp1 is the entire display area; an area Disp11 displays a video with audio (a video with audio formed by the video stream inputted into the simultaneous interpretation device 100 and the display processing device Dev2); and, an area Disp12 is an area for displaying translation result data (word sequence data of the translation target language (Japanese in the case of FIGS. 8 to 10)) obtained by the machine translation processing unit 4. In addition, in FIGS. 8 to 10, an area Disp13 is an area for displaying tag data for identifying the speaker obtained by the simultaneous interpretation device 100 (data displayed as “spk0” and “spk1” in FIGS. 8 to 10)), speaker icon data (icon data consisting of an image of the speaker's face), and translation result data.

### <<In the Case of FIG. 8>>

FIG. 8 shows a scene where a man utters “I'm Smith” in English; segment processing is performed by the segment processing unit 2 of the simultaneous interpretation device 100, the English sentence data “I'm Smith” is obtained as the data Ds_src, and then the sentence data is transmitted to the machine translation processing unit 4. At the same time, the segment processing unit 2 obtains the data D_t_rng of the time range in which the man uttered the English phrase “I'm Smith”, and then the data D_t_rng is transmitted to the speaker prediction processing unit 3. The speaker prediction processing unit 3 specifies the face region of the man who spoke, obtains the man's icon data, and also obtains the man's tag data (data shown as “spk0” in FIG. 8). At this time, the simultaneous interpretation device 100 performs the following processing. In other words, the speaker prediction processing unit 3 of the simultaneous interpretation device 100 obtains the audio included in the video stream in the time range indicated by the data D_t_rng of the time range in which the man uttered “I'm Smith” in English, obtains the embedding representation data D_a_emb for the audio: furthermore, the speaker prediction processing unit 3 obtains the image data D_face of the face region of the person speaking from the video stream in the above time range, and obtains the embedding representation data D_face_emb for the image data. The speaker prediction processing unit 3 performs best matching processing between (1) the obtained embedding representation data D_a_emb for audio and the obtained embedding representation data D_face_emb for face image region data and (2) the data stored in the data storage unit DB1 (embedding representation data for audio and embedding representation data for face image region data); If the score of the matching data exceeds a predetermined threshold, the speaker prediction processing unit 3 determines that the speaker with the best matched speaker ID is the same as the speaker (male) who uttered “I'm Smith”, and then transmits the tag data of the speaker ID to the display processing device Dev2. Conversely, if the score of the matching data does not exceed the predetermined threshold, the speaker prediction processing unit 3 determines that the data of the speaker (male) who uttered “I'm Smith” does not exist in the data storage unit DB1, sets a new ID for the speaker, and further stores the data of the speaker (embedding representation data for audio and embedding representation data for face image region data) in the data storage unit DB1.

The tag data obtained as described above is transmitted from the speaker prediction processing unit 3 to the display processing device Dev2, and is displayed in the area Disp13 by the display processing device Dev2 (in the case of FIG. 8, the tag data is displayed as “spk0”).

Further, the icon data (the icon of the male face region image) obtained by the speaker prediction processing unit 3 is transmitted to the display processing device Dev2, and the display processing device Dev2 displays the icon data in the area Disp13.

Furthermore, the machine translation result data Do_MT obtained by the machine translation processing unit 4 is transmitted to the display processing device Dev2, and then the display processing device Dev2 displays the machine translation result data (in the case of FIG. 8, a word sequence translated from “I am Smith.” into Japanese (word sequence in the translation target language (Japanese)) is displayed in the area Disp13 and the area Disp12 (area for displaying subtitles).

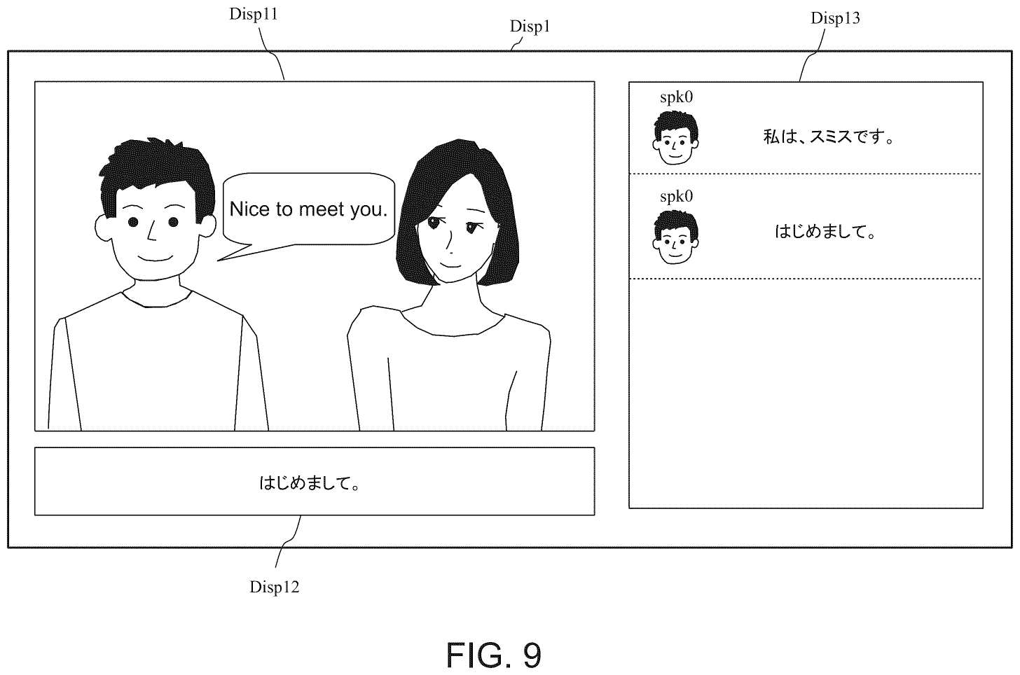

### <<In the Case of FIG. 9>>

FIG. 9 shows a scene where a man utters “Nice to meet you” in English: segment processing is performed by the segment processing unit 2 of the simultaneous interpretation device 100, the English sentence data “Nice to meet you” is obtained as data Ds_src, and then the sentence data is transmitted to the machine translation processing unit 4 (through the segment processing described above, it is determined that the part after the word “you” is a segment delimiter). At the same time, the segment processing unit 2 obtains the data D_t_rng of the time range in which the man uttered the English phrase “Nice to meet you”, and then the data D_t_rng is transmitted to the speaker prediction processing unit 3. The speaker prediction processing unit 3 specifies the face region of the man who spoke, obtains the man's icon data, and also obtains the man's tag data (data shown as “spk0” in FIG. 9). At this time, the simultaneous interpretation device 100 performs the following processing. In other words, the speaker prediction processing unit 3 of the simultaneous interpretation device 100 obtains the audio included in the video stream in the time range indicated by the data D_t_rng of the time range in which the man uttered “Nice to meet you” in English, obtains the embedding representation data D_a_emb for the audio: furthermore, the speaker prediction processing unit 3 obtains the image data D_face of the face region of the person speaking from the video stream in the above time range, and obtains the embedding representation data D_face_emb for the image data. The speaker prediction processing unit 3 performs best matching processing between (1) the obtained embedding representation data D_a_emb for audio and the obtained embedding representation data D_face_emb for face image region data and (2) the data stored in the data storage unit DB1 (embedding representation data for audio and embedding representation data for face image region data); If the score of the matching data exceeds a predetermined threshold, the speaker prediction processing unit 3 determines that the speaker with the best matched speaker ID is the same as the speaker (male) who uttered “Nice to meet you”, and then transmits the tag data of the speaker ID to the display processing device Dev2. In the case of FIG. 9, since the speaker's data has been stored in the data storage unit DB1, the score of the matching data exceeds a predetermined threshold; as a result, the speaker prediction processing unit 3 determines that the speaker (male) who uttered “Nice to meet you” is the speaker corresponding to the tag data “spk0”.

The tag data obtained as described above is transmitted from the speaker prediction processing unit 3 to the display processing device Dev2, and is displayed in the area Disp13 by the display processing device Dev2 (in the case of FIG. 9, the tag data is displayed as “spk0”).

Further, the icon data (the icon of the male face region image) obtained by the speaker prediction processing unit 3 is transmitted to the display processing device Dev2, and the display processing device Dev2 displays the icon data in the area Disp13.

Furthermore, the machine translation result data Do_MT obtained by the machine translation processing unit 4 is transmitted to the display processing device Dev2, and then the display processing device Dev2 displays the machine translation result data (in the case of FIG. 9, a word sequence translated from “Nice to meet you” into Japanese (word sequence in the translation target language (Japanese)) is displayed in the area Disp13 and the area Disp12 (area for displaying subtitles).

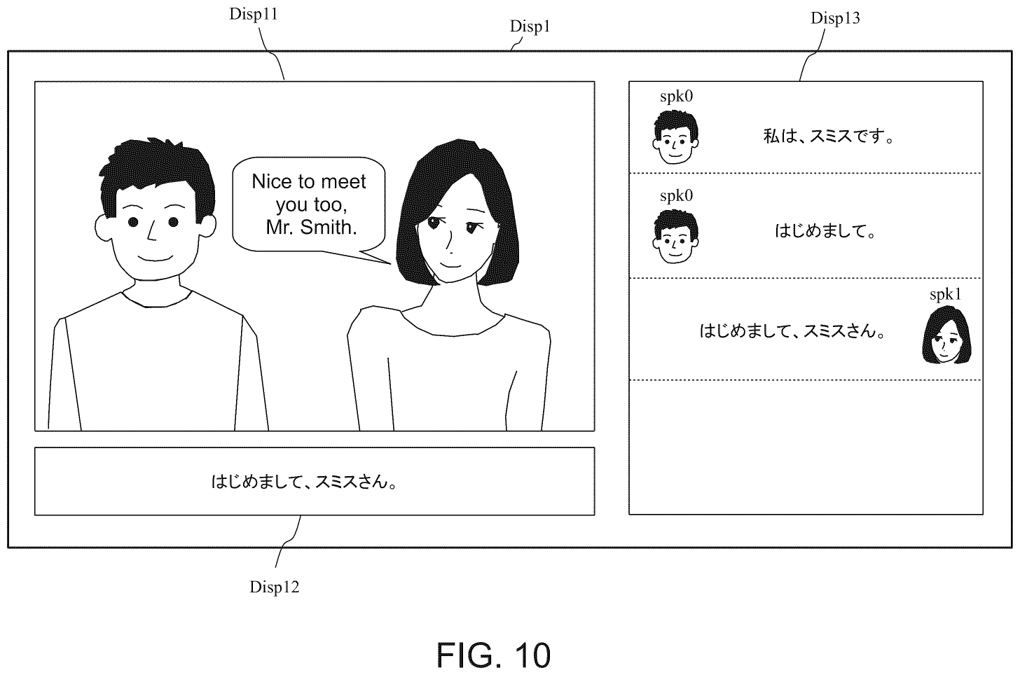

### <<In the Case of FIG. 10>>

FIG. 10 shows a scene where a woman utters “Nice to meet you too, Mr. Smith” in English; segment processing is performed by the segment processing unit 2 of the simultaneous interpretation device 100, the English sentence data “Nice to meet you too, Mr. Smith” is obtained as data Ds_src, and then the sentence data is transmitted to the machine translation processing unit 4. At the same time, the segment processing unit 2 obtains the data D_t_rng of the time range in which the woman uttered the English phrase “Nice to meet you too, Mr. Smith”, and then the data D_t_rng is transmitted to the speaker prediction processing unit 3. The speaker prediction processing unit 3 specifies the face region of the woman who spoke, obtains the woman's icon data, and also obtains the woman's tag data (data shown as “spk1” in FIG. 10). At this time, the simultaneous interpretation device 100 performs the following processing. In other words, the speaker prediction processing unit 3 of the simultaneous interpretation device 100 obtains the audio included in the video stream in the time range indicated by the data D_t_rng of the time range in which the woman uttered “Nice to meet you too, Mr. Smith” in English, obtains the embedding representation data D_a_emb for the audio: furthermore, the speaker prediction processing unit 3 obtains the image data D_face of the face region of the person speaking from the video stream in the above time range, and obtains the embedding representation data D_face_emb for the image data. The speaker prediction processing unit 3 performs best matching processing between (1) the obtained embedding representation data D_a_emb for audio and the obtained embedding representation data D_face_emb for face image region data and (2) the data stored in the data storage unit DB1 (embedding representation data for audio and embedding representation data for face image region data): If the score of the matching data exceeds a predetermined threshold, the speaker prediction processing unit 3 determines that the speaker with the best matched speaker ID is the same as the speaker (female) who uttered “Nice to meet you too, Mr. Smith”, and then transmits the tag data of the speaker ID to the display processing device Dev2. Conversely, if the score of the matching data does not exceed the predetermined threshold, the speaker prediction processing unit 3 determines that the data of the speaker (female) who uttered “Nice to meet you too, Mr. Smith” does not exist in the data storage unit DB1, sets a new ID for the speaker, and further stores the data of the speaker (embedding representation data for audio and embedding representation data for face image region data) in the data storage unit DB1.

The tag data obtained as described above is then transmitted from the speaker prediction processing unit 3 to the display processing device Dev2, and is displayed in the area Disp13 by the display processing device Dev2 (in the case of FIG. 10, the tag data is displayed as “spk1”).

Further, the icon data (the icon of the female face region image) obtained by the speaker prediction processing unit 3 is transmitted to the display processing device Dev2, and the display processing device Dev2 displays the icon data in the area Disp13.

Furthermore, the machine translation result data Do_MT obtained by the machine translation processing unit 4 is transmitted to the display processing device Dev2, and then the display processing device Dev2 displays the machine translation result data (in the case of FIG. 10, a word sequence translated from “Nice to meet you too, Mr. Smith” into Japanese (word sequence in the translation target language (Japanese)) is displayed in the area Disp13 and the area Disp12 (area for displaying subtitles).

In this way, in the simultaneous interpretation system 1000, the machine translation result of the source language uttered by the speaker can be displayed in the area Disp13 along with the tag data and icon data that identify the speaker, thereby allowing a user to easily recognize “who said what”.

In addition, in the simultaneous interpretation system 1000, the segment processing unit 2 of the simultaneous interpretation device 100 performs high-speed and highly accurate segment processing to obtain sentence data, and also obtains data of the time range in which the word sequence included in the sentence data was uttered, thus allowing machine translation processing and speaker identification processing to be performed in real time.

In other words, in the simultaneous interpretation system 1000, the machine translation processing unit 4 performs machine translation processing on the sentence data obtained through high-speed and highly accurate segment processing, and, in parallel, performs speaker identification processing, with the speaker prediction processing unit 3, using data (stream) obtained by clipping the inputted video stream within a time range, thus allowing machine translation processing and speaker identification processing to be performed in real time (processing that is guaranteed to be completed within a predetermined delay time).

### Other Embodiments

Each functional unit of the simultaneous interpretation system described in the above embodiment may be achieved with one device (system), or may be achieved with a plurality of devices.

In the above embodiment, a case has been described in which data D_av (data of a video stream (video stream with AV synchronization)) transmitted from the video stream obtaining processing device Dev1 is inputted into the speech recognition processing unit 1 of the simultaneous interpretation device 100, and the speech recognition processing unit 1 extracts audio data (audio signal) from the data D_av and performs speech recognition processing on the extracted audio data (audio signal); however, the present invention should not be limited to this. For example, audio data (audio signal) with time information may be inputted into the speech recognition processing unit 1 of the simultaneous interpretation device 100, and the speech recognition processing unit 1 may perform speech recognition processing on the audio data, thereby obtaining a word sequence (word stream) corresponding to the audio data (audio signal) and time information on when each word included in the word sequence was uttered. In other words, instead of performing processing, with the speech recognition processing unit 1, for extracting an audio signal and time information from the data D_av (data of a video stream (AV-synchronized video stream)) (data (signal) including time information, a video signal, and an audio signal) inputted into the simultaneous interpretation device 100, for example, an audio signal with time information may be inputted from the video stream obtaining processing device Dev1 into the speech recognition processing unit 1. In this case as well, the speaker prediction processing unit 3 of the simultaneous interpretation device 100 receives data D_av (data of a video stream (AV-synchronized video stream)) (time information, a video signal, and an audio signal).

In the above embodiment, a case has been described in which the input language is English, but the input language should not be limited to English and may be another language. In other words, in the simultaneous interpretation system of the above embodiment, the translation source language and the translation target language may be any language.

In the above embodiment, a case has been described in which the speaker identification processing unit 35 uses the cosine similarity to perform the processing corresponding to Formula 3 to identify a speaker with ID=x′ that is the best matching data from the data stored in the data storage unit DB1; however, the present invention should not be limited to this. For example, the speaker identification processing unit 35 may use distance information (e.g., Euclidean distance) to find x that minimizes {d(v_{f}, v_{f}^{x})+d(v_{f}, v_{f}^{x})} as x′, and may identify a speaker with ID=x′ that is the best matching data from the data stored in the data storage unit DB1. Note that d(v1, v2) is a function that obtains distance information (e.g., Euclidean distance) between data v1 and v2.

Each block of the simultaneous interpretation system 1000 described in the above embodiment may be formed using a single chip with a semiconductor device, such as LSI, or some or all of the blocks of the simultaneous interpretation system 1000 may be formed using a single chip.

Note that although the term LSI is used here, it may also be called IC, system LSI, super LSI, or ultra LSI depending on the degree of integration.

Further, the method of circuit integration should not be limited to LSI, and it may be implemented with a dedicated circuit or a general-purpose processor. A field programmable gate array (FPGA) that can be programmed after the LSI is manufactured, or a reconfigurable processor that can reconfigure connection and setting of circuit cells inside the LSI may be used.

Further, a part or all of the processing of each functional block of each of the above embodiments may be implemented with a program. A part or all of the processing of each functional block of each of the above-described embodiments is then performed by a central processing unit (CPU) in a computer.

The programs for these processes may be stored in a storage device, such as a hard disk or a ROM, and may be executed from the ROM or be read into a RAM and then executed.

The processes described in the above embodiment may be implemented by using either hardware or software (including use of an operating system (OS), middleware, or a predetermined library), or may be implemented using both software and hardware.

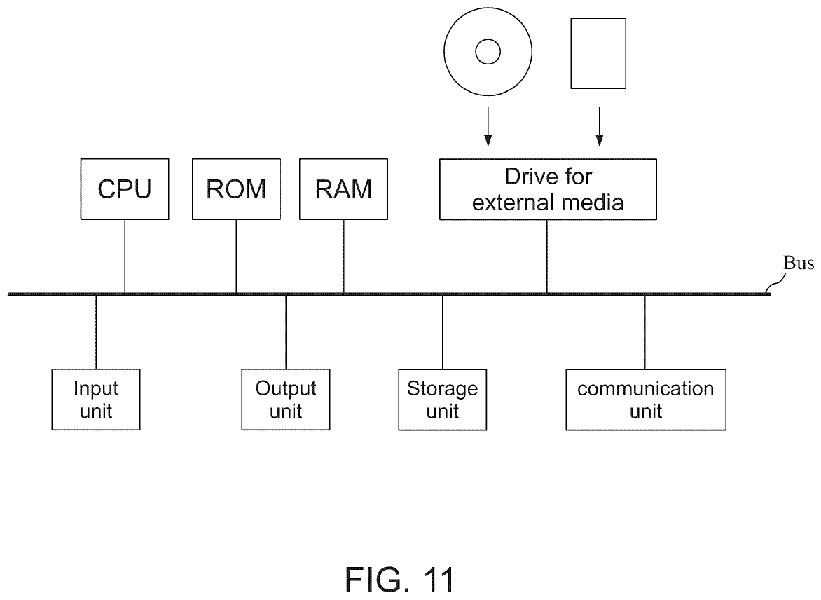

For example, when each functional unit of the above embodiment is achieved by using software, the hardware structure (the hardware structure including CPU(s), GPU(s), ROM, RAM, an input unit, an output unit, a communication unit, a storage unit (eg, a storage unit achieved by using HDD, SSD, or the like), a drive for external media or the like, each of which is connected to a bus) shown in FIG. 11 may be employed to achieve the functional units by using software.

When each functional unit of the above embodiment is achieved by using software, the software may be achieved by using a single computer having the hardware configuration shown in FIG. 11, and may be achieved by using distributed processes using a plurality of computers.

The processes described in the above embodiment may not be performed in the order specified in the above embodiment. The order in which the processes are performed may be changed without departing from the scope and the spirit of the invention. Further, in the processing method in the above-described embodiment, some steps may be performed in parallel with other steps without departing from the scope and the spirit of the invention.

The present invention may also include a computer program enabling a computer to implement the method described in the above embodiment and a computer readable recording medium on which such a program is recorded. Examples of the computer readable recording medium include a flexible disk, a hard disk, a CD-ROM, an MO, a DVD, a DVD-ROM, a DVD-RAM, a large capacity DVD, a next-generation DVD, and a semiconductor memory.

The computer program should not be limited to one recorded on the recording medium, but may be transmitted via an electric communication line, a wireless or wired communication line, a network represented by the Internet, or the like.

The specific structures described in the above embodiment are mere examples of the present invention, and may be changed and modified variously without departing from the scope and the spirit of the invention.

### REFERENCE SIGNS LIST

1000 simultaneous interpretation system
100 simultaneous interpretation device
1 speech recognition processing unit
2 segment processing unit
3 speaker prediction processing unit
31 video clip processing unit
32 audio encoder
33 speaker detection processing unit
34 face encoder
35 speaker identification processing unit
DB1 data storage unit
4 machine translation processing unit
Dev2 display processing device

1. A simultaneous interpretation device comprising:
a speech recognition processing unit that performs speech recognition processing on a video stream including time information, an audio signal, and a video signal to obtain word sequence data corresponding to the audio signal, the word sequence data including time information on when each word in the word sequence was uttered;
a segment processing unit that obtains sentence data, which is segmented word sequence data, by performing segment processing on the word sequence data, and obtains time range data that specifies a time range in which the word sequence included in the sentence data was uttered;
a speaker prediction processing unit that predicts a speaker who speaks in a period specified by the time range data, based on the video stream and the time range data; and
a machine translation processing unit that performs machine translation processing on the sentence data to obtain machine translation processing result data corresponding to the sentence data.

2. The simultaneous interpretation device according to claim 1,
wherein the speaker prediction processing unit includes:
a video clip processing unit that obtains a clip video stream, which is data for a period specified by the time range data, from the video stream;
a speaker detection processing unit that extracts a face image region of a speaker from a frame image formed by the clip video stream;
an audio encoder that performs audio encoding processing on the audio signal included in the clip video stream to obtain audio embedding representation data that is embedding representation data corresponding to the audio signal;
a face encoder that performs face encoding processing on the image data forming the face image region of the speaker to obtain face embedding representation data that is embedding representation data corresponding to the face image region of the speaker; and
a speaker identification processing unit that identifies a speaker who uttered the speech reproduced by the audio signal included in the clip video stream, based on the audio embedding representation data and the face embedding representation data.

3. The simultaneous interpretation device according to claim 2, further comprising:
a data storage unit that stores a speaker identifier that identifies the speaker, and stores the audio embedding representation data and the face embedding representation data that are linked to the speaker identifier,
wherein the speaker identification processing unit performs best matching processing using (1) the audio embedding representation data obtained by the audio encoder and the face embedding representation data obtained by the face encoder, and (2) the audio embedding representation data and the face embedding representation data that have been stored in the data storage unit, and when a similarity score indicating a degree of similarity between the above two data sets in the best matching processing is greater than a predetermined value, the speaker identification processing unit identifies a speaker identified by the speaker identifier corresponding to the audio embedding representation data and the face embedding representation data stored in the data storage unit, which have been used for the matching processing in the best matching processing, as the speaker who uttered the speech reproduced by the audio signal included in the clip video stream.

4. A simultaneous interpretation system comprising:
the simultaneous interpretation device according to any one of claims 1- to 3; and
a display processing device that inputs speaker identification data, which is data for identifying a speaker who uttered speech reproduced by the audio signal included in the video stream, obtained by the simultaneous interpretation device, and the machine translation processing result data corresponding to the sentence data obtained by the machine translation processing unit of the simultaneous interpretation device, and generates display data for displaying the speaker identification data and the machine translation processing result data in one or more predetermined image areas of a screen of a display device.

5. A simultaneous interpretation processing method comprising:
a speech recognition processing step that performs speech recognition processing on a video stream including time information, an audio signal, and a video signal to obtain word sequence data corresponding to the audio signal, the word sequence data including time information on when each word in the word sequence was uttered;
a segment processing step that obtains sentence data, which is segmented word sequence data, by performing segment processing on the word sequence data, and obtains time range data that specifies a time range in which the word sequence included in the sentence data was uttered;
a speaker prediction processing step that predicts a speaker who speaks in a period specified by the time range data, based on the video stream and the time range data; and
a machine translation processing step that performs machine translation processing on the sentence data to obtain machine translation processing result data corresponding to the sentence data.

6. A non-transitory computer readable storage medium storing a program for causing a computer to execute the simultaneous interpretation processing method according to claim 5.
